(19) United States
(12) Patent Application Publication
(10) Pub. No.: US 2008/0295569 A1
(43) Pub. Date: Dec. 4, 2008

(54) Method and Arrangement For Calibration of a System For Determining the Amount of Liquid in a Reservoir

(75) Inventor: Dag Lundstrom, Onsala (SE)

Correspondence Address: WRB-IP LLP, 1217 KING STREET, ALEXANDRIA, VA, 22314, US

(73) Assignee: CPAC SYSTEMS AB, S-421 31 V.Frolunda (SE)

(21) Appl. No.: 12/097,308

(22) PCT Filed: Jan. 2, 2006
(86) PCT No.: PCT/SE2006/000006

§ 371 Date: Jun. 13, 2008

(51) Int. Cl. G01F 25/00

(52) U.S. Cl. 73/1.73

(57) ABSTRACT

A method for calibration of a system for determining the amount of fuel in a fuel tank includes a first step of initiating a start of the calibration, a second step which includes detection of a level of a fuel-level sensor and detection of a point in time at which the level was detected, and further steps corresponding to a periodical repetition of the second step. The calibration is carried out during addition of fuel to the fuel tank at a generally constant flow velocity. An arrangement for such a calibration is also provided.

### BACKGROUND AND SUMMARY

The present invention relates to a method for calibration of a system for determining the amount of fuel in a fuel tank, comprising: a first step of initiating a start of said calibration; a second step which comprises detection of a level of a fuel-level sensor and detection of a point in time at which said level was detected; and further steps corresponding to a periodical repetition of said second step.

The invention also relates to an arrangement for calibration of a system for determining the amount of fuel in a fuel tank, comprising a fuel-level sensor which is connected to a control unit and adapted for detecting the level of fuel in said fuel tank and outputting a signal representing said level to said control unit, wherein said control unit is adapted for detecting an activation of said calibration which comprises steps wherein a fuel level is detected as well as a point in time at which said level was detected, and wherein said control unit is adapted for periodically repeating said steps.

In various fields of technology, there is a need to determine the amount of liquid which is entrapped in a reservoir. For example, such a need exists in vehicles, machines and other arrangements which are powered by combustion engines in which one or several fuel tanks are used.

As previously known, a fuel tank is normally provided with a fuel level sensor in order to indicate to the driver of the vehicle the amount of fuel which is left in the tank at any given moment. One commonly used type of fuel level sensor is a mechanical float sensor, i.e. a mechanical sensor which comprises a float-type gauge which is arranged to float on the surface of the fuel contained in the tank. The float-type gauge is associated with, for example, a tumable resistor, wherein the resistance of the resistor is proportional to the position, i.e. the level, of the gauge. In this manner, the resistance of the sensor can be used as a measure of the fuel level in the tank.

It is obviously important to be able to predict in an accurate manner how much fuel is left in a fuel tank at any given moment when the vehicle is operated. This means that the fuel sensor must be accurately calibrated so that the signal from the sensor corresponds to the actual amount of fuel which is contained in the fuel tank. If information regarding the remaining amount of fuel in a tank can be provided by means of a correctly calibrated sensor, a control unit can for example be used to indicate the maximum possible distance to travel with the vehicle before the tank has to be filled again. Such calculations must obviously be based on correct information regarding the remaining amount of fuel in the fuel tank.

One example of an application for combustion engines having fuel tanks is the field of watercraft. In such case, there is obviously also a demand for providing accurate readings of the fuel level in a fuel tank. For this purpose, fuel tanks for watercraft are often provided with the above-mentioned type of sensor having a float-type gauge.

Also, it is common to use tanks for watercraft which are of flexible material and which may have a non-uniform and irregular shape. This is due to the fact that there is often a requirement to use a tank which is adapted to be fitted into a particular available space in a boat. Such an available space may then be of a non-uniform shape. It can be noted that the dimensions and shape of such an available space may vary from boat to boat, even within the same boat type. Consequently, the geometry and the fuel containing capacity of the fuel tank may vary between individual boats which are of the same model.

As mentioned above, many of today's fuel tanks are equipped with a fuel level sensor which is adapted for measuring the level of fuel surface. Such a sensor does not normally take into account the fact that the fuel tank may have a varying cross-section (along the vertical direction), i.e. as a result of a non-uniform and irregular shape. This makes it difficult to provide accurate readings of the remaining fuel in such a tank, since a uniform movement of a float-type gauge in a sensor will not correspond in a linear manner to an equally uniform movement of the actual remaining fuel in the tank as fuel is fed out of the fuel tank. This means that the float sensor cannot be used for detecting changes of the fuel level in a tank without being calibrated, since this would lead to inaccurate measurements of the fuel level.

For this reason, there is a demand for ways of calibrating a system for determining the fuel level in a tank, in particular for a fuel tank in a watercraft. Using a suitable calibration process means that the readings, i.e. the actual information, from the sensor can be adapted so as to actually correspond to the fuel level in a true and accurate manner. In this regard, there is a need to calibrate the relationship between the liquid level (as detected by a fuel-level sensor) and the volume of the fuel remaining in the fuel tank, while taking account of the fact that the fuel tank may be designed with a non-uniform or irregular shape. In particular, the sensor system must normally be calibrated for each individual boat of a particular boat type.

According to prior art, it is known that such a calibration can be carried out as a manual calibration of the sensor with regard to the tank cross-section. This is obtained by manually pouring a known amount of fuel into the tank and simultaneously recording the tank level sensor signal. This process is then repeated a number of times. In this way, a correlation between the fuel sensor signal and the true surface level of the fuel in the fuel tank can be obtained. However, a drawback with this method is that it is a manual process which is relatively time-consuming. Also, this type of calibration is not very accurate.

A further known method for calibrating a fuel-level detecting system is known from the patent document US 2004/0149003. This document discloses a method and arrangement for determining the fill characteristics of a fluid tank arranged in a watercraft. In particular, the arrangement uses a liquid withdrawal arrangement, for example in the form of the fuel delivery system of the engine of the watercraft in question. This arrangement can be used in a manner involving a pairing of top surface positions and associated amounts of remaining fuel in the tank. This corresponds to a mapping of the remaining fuel quantity as a function of the fuel surface level.

Although the previously known systems and methods are useful for calibrating a fuel level sensor for a fuel tank in a watercraft, there is still a need for further improvements in this field of technology, in particular for providing calibrations which are simple, fast and reliable and which may optionally be operated in an automatic manner.

It is desirable to provide an improved method and arrangement for calibrating a system for determining the amount of liquid̂ in a reservoir, in particular for a reservoir in the form of a fuel tank. The invention is particularly, but not exclusively, intended to be used in watercraft.

In a method according to an aspect of the present invention, said calibration is carried out during addition of fuel to said fuel tank at a generally constant flow velocity.

In an arrangement according to an aspect of the present invention, said control unit is adapted for carrying out said process while fuel is added to said fuel tank at a generally constant flow velocity.

By means of aspects of the invention, certain advantages will be accomplished. For example, the calibration process according to the invention can be obtained in a practical and simple manner. In particular, the calibration process can be initiated in an automatic manner. In fact, a complete calibration of a fuel-level sensor can be accomplished while filling fuel in a fuel tank in the normal manner at a conventional fuel station. Also, the calibration is carried out regardless of the shape and geometry of the fuel tank in question, and even in those cases where the shape of the fuel tank differs between individual boats of the same type.

A particular advantage of an aspect of the invention is that it is not necessary to actually measure the amount of fuel which is filled into the fuel tank while the calibration is carried out. This is because an aspect of the invention is based on the assumption of an essentially constant flow of velocity of the fuel which is added to the fuel tank during calibration.

### BRIEF DESCRIPTION OF DRAWINGS

In the following, the invention will be described with reference to the appended drawings, wherein:

FIG. 1 is a simplified side view of a fuel tank for a watercraft being arranged in accordance with the present invention;

FIG. 2 describes in a schematical manner a calibration process according to the invention; and

FIG. 3 shows a graph which describes the filling level vs. time of a fuel tank during calibration according to the invention.

### DETAILED DESCRIPTION

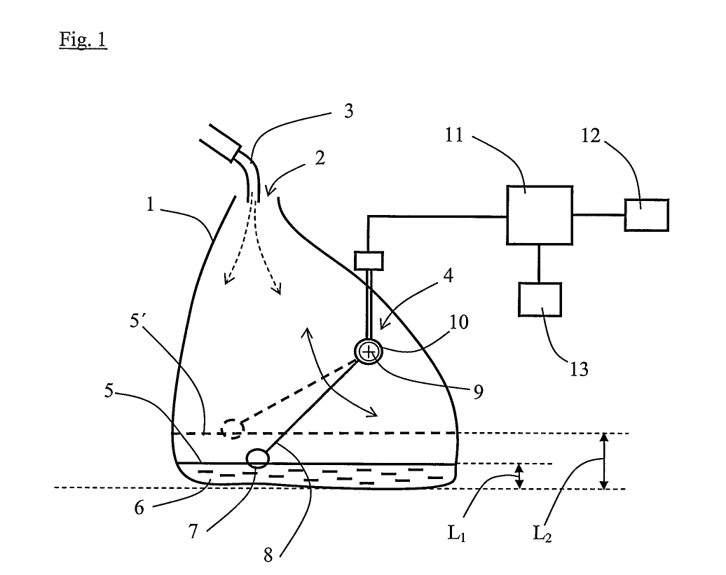

FIG. 1 shows a simplified side view of a fuel tank 1 in which the present invention can be used. Generally, the invention can be used for any type of liquid reservoir, but the invention is particularly advantageous for use with fuel tanks. Also, the invention can generally be used in any type of fuel tank, but is primarily intended for fuel tanks to be used in different types of watercraft, both larger commercial ships, smaller watercraft such as leisure boats and other types of water vehicles or vessels. It can be noted that the invention is particularly useful for fuel tanks in small leisure boats.

The fuel tank 1 is shown separately in FIG. 1, i.e. it is not shown mounted in a watercraft. However, the skilled person will realize that such a fuel tank 1 is intended to be mounted in a suitable space in a watercraft. It is here assumed that the fuel tank 1 is of a non-uniform and irregular shape in order to fit into a given space (which also can be expected to be non-uniform and irregular) in the watercraft in question. It should be noted that the invention is not limited to be used with a fuel tank of any particular size, shape or geometry.

The upper region of the fuel tank 1 is provided with an opening 2 which is arranged to receive a fuel dispenser device 3 during filling of the fuel tank 1. FIG. 1 shows in a schematical manner how fuel is pumped into the fuel tank 1 by means of the fuel dispenser device 3. It should be noted that the opening 2 is arranged to receive a conventional type of fuel dispenser device 3 which is commonly used in fuel stations of the type which is common in marinas and harbours.

The fuel tank 1 is provided with a fuel-level sensor 4 for detecting the level, or height, of the surface 5 of a certain amount of fuel 6 which is contained within the fuel tank 1. To this end, the fuel-level sensor 4 preferably comprises a mechanical gauge 7 of the type which is arranged to float on said surface 5. During filling of the fuel tank 1, the fuel surface 5 will gradually be raised, which means that the float-type gauge 7 will also be raised since it floats on the surface 5. In order to illustrate this, FIG. 1 also shows the surface 5′ at a certain raised level which consequently has been reached after a certain amount of fuel has been added to the fuel tank 1.

Furthermore, the floating gauge 7 is attached to a rod 8 which is pivotably arranged about an axis 9. The pivoting movement of the rod 8 is indicated in FIG. 1 by means of an arrow. In a manner which is previously known as such, the pivotable rod 8 is also associated with a sensor providing a signal which depends on the position of the pivotable rod 8. According to the embodiment, the sensor is constituted by a resistor 10, suitably in the form of a turnable resistor, the resistance of which depends on the rotational position of the pivotable rod 8. This means that the height, or level, of the fuel surface 5 can be detected as a resistance value which corresponds to the actual position of the floating gauge 7.

By means of the fuel-level sensor 4, an electrical signal representing the fuel level can consequently be output from the fuel-level sensor 4 and transmitted to a control unit 11. The control unit 10 is preferably computer-based and is arranged in the same watercraft as the fuel tank 1 with its fuel-level sensor 4. The control unit 11 is preferably connected to a display unit 12. In a manner which is known as such, the display unit 12 is adapted to indicate, to the driver of the watercraft, relevant information regarding the amount of fuel in the fuel tank. The control unit 11 is suitably also arranged to calculate the approximate distance which is possible for the watercraft to travel before the fuel tank 1 is empty. This is normally obtained by means of stored information relating to the average fuel consumption of the watercraft per nautical mile and the currectly available amount of fuel in the fuel tank 1. Information relating to the possible travel distance is suitably also available to the driver via the display 12.

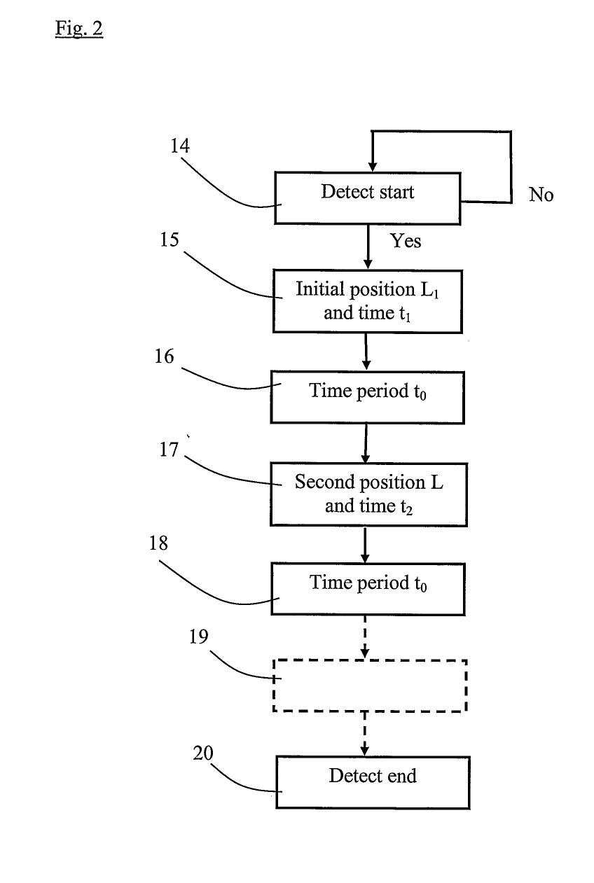

The control unit 11 can also be associated with certain other input devices, indicated schematically by means of reference numeral 13 in FIG. 2. Such an input device 13 will be described in detail below, and can be constituted by an activating device for initiating a calibration process for the system comprising the fuel-level sensor 4, the fuel tank 1 and the control unit 11.

As mentioned initially, there exist certain problems with prior art relating to the calibration of systems for determining the amount of liquid in a reservoir. With the aim of overcoming the problems of prior art, the present invention is based on the general principle that it can be assumed that a calibration can be carried out while the fuel tank 1 is filled with fuel at a generally constant flow velocity. This means that the volume of fuel which is transferred into the fuel tank 1 per unit of time is approximately constant during a calibration process.

According to the invention, it is not necessary to actually measure the amount of fuel being filled into the fuel tank 1 during a calibration process. Similarly, it is not necessary to measure the actual magnitude of the flow velocity during calibration. This is an advantage since it allows the calibration according to the invention to be carried out in an automatic and simple manner while filling a fuel tank at a conventional fuel station for a watercraft, i.e. while filling the fuel tank by means of a conventional fuel pump at such a fuel station. This means that the invention can be used for calibration in a very simple and convenient manner during each occasion that the fuel tank is filled, if this should be necessary.

It is true that different fuel stations operate with fuel pumps which may have different fuel flow velocities. However, regardless of the actual magnitude of the flow velocities, it can generally be assumed that the flow velocity is essentially constant in the fuel pumps in today's fuel stations.

A process for calibrating the described system, for detecting the amount of fuel in the fuel tank, will now be described in detail with reference to FIG. 1 but also with reference to FIG. 2, which is a schematical and simplified flow diagram showing the calibration process.

The first step in the process is that the control unit 11 will await an indication that the actual calibration is being initiated. This is shown by means of reference numeral 14 in FIG. 2. According to the invention, the manner in which the calibration process is initiated can be implemented in several ways. According to a first embodiment, the initiation 14 of the calibration can be provided by means of the input device 13 (cf. FIG. 1). To this end, the input device 13 may be in the form of a push button which can be pressed manually, i.e. activated, when a calibration is required. The input device 13 is suitably activated just after filling of the fuel tank 1 has been started.

According to a second embodiment, the start of the calibration process can be initiated in an automatic manner, suitably by detecting changes in the response from the fuel-level sensor 4. Here it is assumed that changes in the pivotal movement, i.e. the positioning, of the float-type gauge 7 can be detected by means of the control unit 11. More precisely, the rate of change of the float-type gauge 7, i.e. the rate of change of the height of the fuel surface 5, is detected and calculated by the control unit 11 during a specified time period. If the rate of change of the float-type gauge 7 is positive and exceeds a predetermined limit value, this is assumed to be equivalent to the start of filling fuel into the fuel tank 1. In such case, the calibration process can also be started, provided that the engine of the watercraft in question is also switched off. If the filling of fuel is carried out at a conventional fuel station as discussed above, it can then be assumed that the filling is carried out at a generally constant flow velocity.

According to a third embodiment of the invention, the calibration process can be initiated by means of a combination of activating the input device 13 and the occurrence of a rate of change of the fuel surface level which exceeds a predetermined threshold value. This means that both these conditions must be fulfilled for the calibration to start. Preferably, the condition that the input device 13 is activated be detected before the condition that the rate of change exceeds said threshold value.

When the conditions for start of the calibration are fulfilled, the actual calibration process is initiated. This means that an initial position of the fuel-level sensor 4, i.e. an initial fuel surface level Li, is detected by means of the signal from the sensor 4 being detected by the control unit 11. This step is indicated by means of reference numeral 15 in FIG. 2. The initial level L₁ is also indicated in FIG. 1 and corresponds to a first surface level 5 of the fuel 6 in the fuel tank 1 during the calibration.

The detection of the initial level L₁ is furthermore associated with a registration of a certain point in time t when said detection was carried out. Furthermore, when a predetermined time period to has elapsed, as indicated by reference numeral 16 in FIG. 2, a second fuel level L₂ is detected by means of the control unit 11. The second level L₂ is also indicated in FIG. 1 and corresponds to a second surface level 5′ after a certain amount of fuel has been added to the fuel tank 1. Also, the value corresponding to the second level L₂ is associated with the point in time t₂ at which it was detected. The detection of the second level L₂ and the second time t₂ is indicated with reference numeral 17 in FIG. 2.

After detection of the second level L₂, the above-mentioned time period to will once again elapse, as shown with reference numeral 18 in FIG. 2. After this step, the level of the sensor 4 is once again detected together with its corresponding point in time. This process is then continued in a periodical manner until the fuel tank is filled or until a predetermined condition for terminating the calibration it fulfilled. This repeated process is indicated by means of reference numeral 19 in FIG. 2.

According to a first alternative, the calibration process is repeated until the input device 13 (cf. FIG. 1) is activated once again, which corresponds to termination of the calibration process. According to a second alternative, the calibration is terminated upon detection of a rate of change of the fuel level which is zero or which is less than a predetermined limit value, which is preferably close to zero. This corresponds to the fuel dispenser device being shut off after filling of fuel. According to a third alternative, the calibration is terminated when the signal from the fuel-level sensor 4 exceeds a predetermined limit value, for example a limit value which corresponds to a full fuel tank. Also, it can be assumed by the control unit 11 that the filling of fuel is terminated when the signal from the fuel-level sensor indicates that the rate of change of the sensor signal is below a certain threshold value. In other words, it would then not be necessary to push any button or similar on the input device 13 when the calibration is to be terminated. Each one of these alternative ways of terminating the calibration process can be combined with any of the three above-mentioned embodiments of initiating the calibration process.

Consequently, according to the invention, the calibration process is maintained while the fuel tank is filled with fuel at a substantially constant flow velocity, i.e. from a generally empty condition to a generally full condition. This is carried out in a manner wherein values indicating the fuel level and corresponding points in time are registered in a periodical manner by means of the fuel-level sensor 4 and the control unit 11. When this process is terminated, the control unit 11 will contain information representing a complete mapping of the relationship between the readings from the fuel-level sensor 4 and the fuel volume in the fuel tank 1. Since the flow velocity is generally constant during the calibration, it can be assumed that the same amount of fuel has been filled into the fuel tank 1 between two subsequent readings.

As a result of the above-mentioned calibration, the volume at each fuel-level sensor 4 recording will be known. This means that the values emitted from the fuel-level sensor 4 when the watercraft is operated will correspond to a certain amount of fuel which is left in the fuel tank 1. The amount of fuel which is contained in the fuel tank 1 can be expressed either as an exact volume (expressed in litres or gallons) or as a percentage of a full tank (in case the actual volume of the fuel tank 1 is not known). By performing a calibration in accordance with the invention in the above-mentioned manner, the calibration can be carried out with a high degree of accuracy.

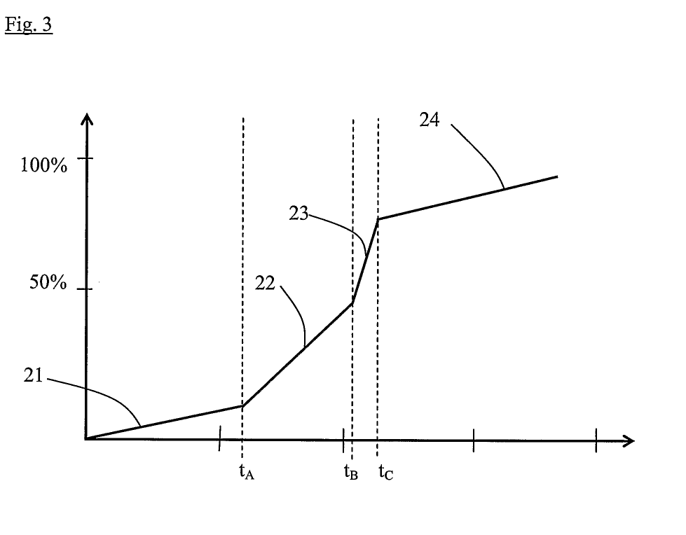

During the calibration process as described above, the relationship between the signal from the fuel-level sensor 4 and time can be represented by means of a graph, as shown schematically in FIG. 3. The graph of FIG. 3 illustrates the relationship between the fuel-level sensor signal along the y axis and time along the x axis, and is based on the values provided during the calibration. In this particular example, the fuel-level sensor signal is indicated along the y axis as a percentage of a full tank. Alternatively, the fuel-level sensor signal can be represented by a numerical value corresponding to the actual volume of the fuel tank in question.

It should be noted that the graph according to FIG. 3 does not necessarily correspond to the design of the fuel tank 1 shown in FIG. 1.

The graph shown in FIG. 3 has a shape which corresponds to four stages, as indicated by reference numerals 21, 22, 23 and 24. The first stage 21 corresponds to a relatively low liquid level change rate, i.e. a relatively low rate at which the level detected by the fuel-level sensor 4 increases. The second stage 22, which can be said to start at a particular point in time tA, presents a higher liquid level change rate than the first stage. The third stage 23, which starts at another point in time t[beta], has an even higher liquid level change rate than the second stage 22. Finally, the fourth stage 24, which starts at yet another point in time tc, presents a liquid level change rate which is generally of the same magnitude as the first stage 21.

Using the above-mentioned principles during calibration, a number of samples, i.e. combinations of numerical values representing the fuel-level and time readings (L₁, t₁; L₂, t₂ etc.), have been collected and stored in the control unit 11. FIG. 3 is a graphical representation of this collection of samples. By using a relatively high sampling rate, i.e. a relatively short time period to (cf. FIG. 2) between consecutive samples, a very high accuracy can be obtained in the calibration process. However, a high sampling rate also means that the memory requirements for the control unit 11 will be relatively substantial. For this reason, and according to a particular embodiment of the invention, the sampling rate during calibration can be adapted depending on the rate at which the fuel level increases during said calibration. According to this embodiment of the invention, the sampling rate during calibration is adapted so that a relatively large amount of samples are stored if the rate of level change rate is relatively large, and a relatively small amount of samples are stored if the rate of level change rate is relatively small. In this manner, the memory requirements for storing the sampled values can be decreased, which is also cost-saving. In practice, and with reference to FIG. 3, this would mean that the only points at which samples have to be generated are points corresponding to the initiation of the calibration, the termination of the calibration, and also points corresponding to t_{A}, t_{B} and t_{C}.

Consequently, according to this embodiment and with reference to FIG. 2, the time period between said second step 15 and the second step 17, and also the time period between the further steps 17, 19 etc. is variable and is adapted depending on the rate of change of the fuel level during said calibration. Alternatively, the actual sampling rate is always kept constant but the actual storing of data to the control unit 11 and its memory is adapted so that data is stored more often if the rate of change from the fuel-level sensor is relatively large, and data is stored more seldom if the rate of change from the fuel-level sensor is relatively small.

The graph according to FIG. 3 illustrates a calibration process which can be said to be linear, in the sense that a first rate of change (i.e. corresponding to the first stage 21) is generally constant and is followed by a second rate of change (i.e. the second stage 22) which is also generally constant. The same linearity occurs also during the third and fourth stages 23, 24.

In the case of a non-linear calibration process, the rate of change of the fuel level will not be generally constant but will change continuously in a manner which depends on the shape and dimensions of the fuel tank. In such a case, the invention can be arranged so that the sampling rate is adapted, but in this case the relative rate of change of the fuel level is used for the adaption of the sampling rate. For example, the rate of change at a particular point in time can be divided by the rate of change at a further point time, according to the following relationship:

RT(n)=(T(n+1)−T(n))/((T(n)−T(n−1))

where RT(n) corresponds to the relative rate of change at a given sampling point n, i.e. at a particular point in time. In this case the relative rate of change may control the sampling rate, preferably so that a low relative rate of change corresponds to a relatively low sampling rate and a high relative rate of change corresponds to a relatively high sampling rate.

According to a further embodiment of the invention, the sampling rate is controlled by the rate of level change rate. This means that the rate of level change rate can be described according to the following relationship:

D2T(n)=T(n+1)−2T(n)−T(n−1)

where D2T(n) corresponds to the rate of level change rate at a given sampling point n, i.e. at a particular point in time. According to this embodiment of the invention, the rate of level change rate change controls the sampling rate suitably in a manner so that a low rate of level change rate corresponds to a relatively low sampling rate and a high rate of level change rate corresponds to a relatively high sampling rate.

With reference to FIGS. 1-3, it should be noted that the above-mentioned calibration procedure can be carried out in a situation wherein the fuel tank 1 is filled from a generally empty condition to a generally filled condition. However, the present invention is not limited to such a situation only, but can also be used when the fuel tank 1 is filled from a partly filled condition, and to a completely filled (or partly filled) condition. Alternatively, the calibration procedure can be carried out in a manner wherein it is terminated at another condition than when the fuel tank 1 is completely filled. For example, a first calibration procedure can be carried out in which the fuel tank 1 is filled from a 10% filling degree to a 20% filling degree. Subsequently, the fuel tank 1 may be filled from a 50% filling degree to a 90% filling degree. Such “partial” calibration procedures can then be combined by means of the control unit 11, on the condition that they overlap at least partly, in order to gradually produce a generally complete calibration of the entire fuel 1 tank. Such an overlapping calibration procedure may correspond to a first filling from, for example, a 10% filling degree to a 30% filling degree, and then a second filling from a 20% filling degree and to a 50% filling degree. Since the starting point for the second filling is less than the finishing point for the first measurement, the procedure can be said to be “overlapping”. Also, it should be noted that the accuracy of such a calibration process generally will increase if it comprises a relatively large number of measurements during said fillings and if filling rate adjusted average values are calculated for the output signals from the fuel-level sensor 4.

The present invention is not limited to the above-mentioned embodiment, but can be varied within the scope of the appended claims. For example, the invention is suitable for all watercraft which use a fuel tank with a fuel-level sensor. Similarly, the invention is not limited to any particular type of fuel-level sensor but can be used with sensors based on a mechanical floating gauge, sensors based on ultrasonic technology and sensors based on other physical phenomena used for detecting a fuel surface level.

Also, the fuel tank 1 can be arranged with various shapes and with various dimensions.

1. A method for calibration of a system for determining the amount of fuel in a fuel tank, comprising:
a first step (of initiating a start of the calibration;
a second step which comprises detection of a level of a fuel-level sensor and detection of a point in time at which the level was detected; and
further steps corresponding to a periodical repetition of the second step;
wherein the calibration is carried out during addition of fuel to the fuel tank at a generally constant flow velocity.

2. A method according to claim 1, wherein the start of the calibration is initiated by detecting a manual activation of an input device.

3. A method according to claim 1, wherein the start of the calibration is initiated in an automatic manner by detecting whether a rate of change of the fuel level during filling of the fuel tank exceeds a predetermined limit value.

4. A method according to claim 1, wherein the start of the calibration is initiated as a result of the two following conditions being fulfilled: detecting a manual activation of an input device; and subsequently detecting whether a rate of change of the fuel level during filling of the fuel tank exceeds a predetermined limit value.

5. A method according to claim 1, wherein the repetition of the second step and further steps are carried out at a generally constant periodicity defined by a predetermined time period.

6. A method according to claim 1, wherein a time period between the second step and further steps is variable and is adapted depending on the rate of change of the fuel level during the calibration.

7. A method according to claim 1, wherein a start of the calibration is carried out at a fuel level in the fuel tank which corresponds to a generally empty tank or at a fuel level which is higher than an empty tank.

8. A method according to claim 1, wherein the calibration is terminated at a fuel level in the fuel tank which corresponds to a generally full tank or at a fuel level which is less than a full tank.

9. A method according to claim 1, wherein a fuel level at which it is a calibration initiated is less than the fuel level at which a previous calibration was terminated.

10. An arrangement for calibration of a system for determining the amount of fuel in a fuel tank, comprising a fuel-level sensor which is connected to a control unit and adapted for detecting the level of fuel in the fuel tank and outputting a signal representing the level to the control unit, wherein the control unit is adapted for detecting an activation of the calibration which comprises steps wherein a fuel level is detected as well as a point in time at which the level was detected, and wherein the control unit is adapted for periodically repeating the steps, wherein the control unit is adapted for carrying out the process while fuel is added to the fuel tank at a generally constant flow velocity.

11. An arrangement according to claim 10, wherein the fuel-level sensor comprises a float-type gauge arranged in the fuel tank.

12. An arrangement according to claim 10, wherein the fuel tank is arranged for mounting in a watercraft.
